(19) United States
(12) Patent Application Publication
(10) Pub. No.: US 2021/0379801 A1
(43) Pub. Date: Dec. 9, 2021

(54) PRODUCTION PROCESS OF A COMPOSITE PRODUCT

(71) Applicant: PERSICO S.p.a., NEMBRO (IT)

(72) Inventor: Sergio Battista GASTALDI, NEMBRO (IT)

(73) Assignee: PERSICO S.p.a., NEMBRO (IT)

(21) Appl. No.: 17/288,120

(22) PCT Filed: Oct. 28, 2019
(86) PCT No.: PCT/IT2019/050230

§ 371 Date: Apr. 23, 2021

(30) Foreign Application Priority Data
Nov. 9, 2018 (IT) 102018000010223

(51) Int. Cl. B29C 43/18; B32B 27/34; B32B 27/12; B32B 29/02; B32B 37/02; B32B 5/02; B32B 3/12; B32B 27/30; B32B 37/15; B32B 37/14; B32B 38/00; B32B 27/20; B32B 38/08; B29C 43/36; B29C 51/10; B29C 51/26; B29C 51/32; B29C 51/36; B29C 70/08; B29C 70/44

(52) U.S. Cl. CPC B29C 43/183; B29K 2075/00; B32B 27/12; B32B 29/02; B32B 37/02; B32B 5/02; B32B 3/12; B32B 27/302; B32B 37/15; B32B 37/146; B32B 38/0004; B32B 27/20; B32B 38/08; B29C 43/36; B29C 51/10; B29C 51/264; B29C 51/32; B29C 51/36; B29C 70/086; B29C 70/44; B32B 2250/40; B32B 2260/023; B32B 2375/00; B32B 2325/00; B32B 2377/00; B32B 2262/101; B32B 2260/046; B32B 2305/024; B32B 2305/07; B32B 2305/30; B32B 2307/4026; B32B 2307/71; B32B 2315/085; B32B 2309/02; B29C 2043/3605; B32B 27/34

(57) ABSTRACT

Production process of a composite product (1) comprising a core (2), a first layer (3) comprising a sheet impregnated with a solid polyurethane material, and a polymer-based film (7) applied to the first layer (3), wherein the process comprises:
producing a semi-finished product comprising the core (2) and the sheet impregnated by a liquid mixture precursor of the solid polyurethane material;
adhering the film (7) to a first half-mould (11) by applying a depression between the film (7) and the half-mould (11);
pressing two half-moulds (11, 12) against each other with the semi-finished product interposed between two shaping surfaces (13), so that the film (7) comes into contact with the liquid mixture;
with the semi-finished product in the mould, thermosetting the liquid mixture to transform it into the polyurethane solid material so that the film (7) firmly adheres to the first layer (3) and thus producing the composite product (1).

### TECHNICAL FIELD OF THE INVENTION

The present invention relates to a production process of a composite product.

### STATE OF THE ART

It is known realizing composite products, such as typically sandwich panels, comprising a core, typically of honeycomb cardboard or of solid foams, and an upper layer and a lower layer, with reduced thickness, arranged at opposite faces of the core. Each layer is composed of a fiberglass sheet impregnated with a polyurethane material which also partially penetrates the core, to fix the whole.

The so composed structure has a considerably better static behaviour than the individual parts from which it is made. The lower and upper layers perform the function of distributing the loads in the plane, while the core, which occupies almost the whole thickness, the one of increasing the flexural and torsional stiffness of the panel, which depends on the distance of the layers from the middle plane, all with a reduced overall weight.

Such composite panels are widely used, for example for sports equipment such as skis or snowboards, or in the automotive sector, for example to make load planes, hat boxes, box bottoms, etc.

For the realization of the sandwich panels typically a panel semi-finished product is first made by assembling the core and the two fiberglass sheets, and by spraying the sheets to impregnate them with a liquid mixture precursor of the polyurethane material (e.g. a mixture of polyol and isocyanate). The semi-finished product is then subjected to a hot compression molding process (for example at 130-140° C. in the case of polyurethane), in which it is used a mould consisting of two half-moulds which are pushed against each other with the interposition of the semi-finished product. In this way the semi-finished product is formed, by conformation of the surfaces and cutting of its contour, and furthermore the liquid mixture crosslinks to make the solid polyurethane material which fixes the final form of the sandwich panel.

### SUMMARY OF THE INVENTION

The Applicant has realized that the known production processes of the composite products, and the related known composite products, have some drawbacks and/or can be improved in one or more aspects.

The Applicant has firstly found that it is desirable to equip the aforesaid composite products with at least one external surface treated to give particular properties to the surface itself, such as for example one or more among: improved mechanical properties (e.g. anti-scratch, anti-wear, etc.), water-tightness and wash-ability properties, tactile properties, aesthetic properties (e.g. colours, decorations, textures, etc.), anti-UV properties.

The Applicant has also realized that it is possible to make the aforesaid treated surface by coating of the surface with a suitable thin film. However the Applicant has ascertained that the application of the film to the aforesaid composite products downstream of the aforesaid moulding process, for example by lamination or gluing or thermoforming, involves an increase of the times and/or costs of production of the finished composite product and/or it does not guarantee the desired quality of the finished product, in terms for example of adhesion of the film or uniformity of spreading (‘smoothness’) of the film (i.e. absence of folds or wrinkles).

The Applicant has therefore faced the problem of developing a production process of a composite product comprising at least one surface coated with a thin polymer-based film, which entails limited times and/or costs, typically substantially comparable to the times and/or costs of the traditional processes, while guaranteeing the desired quality in terms of spreading uniformity and/or sturdiness and/or duration of the coating of the surface of the composite product.

According to the Applicant the problem of realizing one or more of these objects is solved by a production process of a composite product according to the attached claims and/or having the following features.

According to an aspect the invention relates to a production process of a composite product.

The composite product (when finished) comprises a core, at least a first layer at a first face of the core, the first layer comprising a sheet impregnated with a solid polyurethane material, and a polymer-based film applied to said first layer at the opposite side with respect to said first face of the core.

Preferably the process comprises:
producing a semi-finished product comprising said core and, at the first face of the core, said sheet impregnated by a liquid mixture precursor of said solid polyurethane material;
providing a mould comprising two half-moulds each having a respective shaping surface;
adhering said film to said shaping surface of a first of said two half-moulds by applying a depression between said film and said shaping surface;
forming the semi-finished product by pressing said two half-moulds against each other with said semi-finished product interposed between the two shaping surfaces, so that said film comes into contact with the liquid mixture which impregnates said sheet at the first layer;
with the semi-finished product in the mould, thermosetting said liquid mixture to transform it into said polyurethane solid material so that said film firmly adheres to said first layer and thus producing the composite product.

With the expression depression between said film and said shaping surface it is meant a pressure lower than the atmospheric pressure made in the space delimited by the film and by the shaping surface (in order to make them mutually adhere) or more in general the realization of a pressure difference between the face of the film facing toward the shaping surface and the opposite face.

With the term film it is meant a sheet with sufficient flexibility to be able to be shaped to adhere to the surface of the half-mould by means of a moderate depression, for example greater than 0.1 bar. For example, depending on the selected polymeric material, the sheet typically has a thickness not greater than 1 mm.

According to the Applicant the adhesion of the film to the first half-mould by means of a depression and the thermosetting of the liquid mixture with the film in contact with the liquid mixture which impregnates the sheet, allows the inclusion of the film into the composite product directly during the molding step of the semi-finished product (comprising at least the forming and the thermosetting), without using any fixing means (e.g. adhesive) or process step (e.g. thermoforming, rolling, etc.) further to the traditional process described above.

The present invention achieves an intimate, resistant and durable adhesion of the film to the first layer. The use of the depression causes the film to be spread evenly, i.e. substantially without folds or wrinkles, thanks to the depression's ability to tension even very thin films (e.g. having thickness less than 250 μm) and very flexible, which otherwise would tend to wrinkle.

The present invention in one or more of the aforesaid aspects can have one or more of the following preferred features.

Typically said composite product (when finished) comprises a second layer at a second face of the core opposite to the first face of the core, the second layer comprising a further sheet impregnated with said polyurethane solid material, and wherein said semi-finished product comprises, at the second face of the core, said further sheet impregnated with said liquid mixture precursor of said polyurethane solid material. In this way the mechanical resistance of the product is enhanced.

In an embodiment said composite product (when finished) comprises a further polymer-based film (preferably equal to said film) applied to said second layer at the opposite side with respect to said second face of the core.

Preferably the process comprises:
adhering said further film to said shaping surface of a second of said two half-moulds by applying a depression between said further film and said shaping surface of the second half-mould;
during said forming the semi-finished product, said further film comes into contact with the liquid mixture which impregnates said further sheet;
during said thermosetting said liquid mixture, said further film firmly adheres to said second layer.

Preferably said core and/or said first and/or second layer have substantially laminar development.

Preferably said sheet is made of fiberglass, carbon or kevlar, or natural fibres, more preferably fiberglass (advantageously cheap).

Preferably said core comprises (or consists of) a honeycomb cardboard or a solid foam (with open or close cells), more preferably a honeycomb cardboard having cells with perpendicular development to said first face of the core (to give rigidity and sturdiness). Preferably said polyurethane material is based on diphenylmethane diisocyanate (MDI), even more preferably 4,4′-diphenylmethane diisocyanate (4.4′-MDI). Preferably said liquid mixture is a mixture of polyol and isocyanate, more preferably MDI, even more preferably 4,4′-MDI (due to its wide availability and affordability).

Preferably producing said semi-finished product comprises spraying said sheet (and said further sheet) with said liquid mixture.

Preferably said first (and/or second) half-mould comprises/comprise a respective body having said shaping surface and a cutting blade system.

Preferably forming the semi-finished product comprises cutting said semi-finished product at least along a contour line, more preferably by means of said blade system. Preferably thermosetting the liquid mixture comprises keeping the semi-finished product inside the mould at a given temperature, more preferably greater than 120°, even more preferably greater than 130°, for a given time interval.

Preferably said depression is greater than or equal to 0.1 bar and/or less than or equal to 0.9 bar.

Preferably said film (and said further film) has a thickness greater than or equal to 10 μm, more preferably greater than or equal to 20 μm, even more preferably greater than or equal to 30 μm and/or less than or equal to 500 μm, more preferably less than or equal to 250 μm, even more preferably less than or equal to 200 μm or 150 μm. This thickness is sufficient to give to the surface at least one of the aforementioned properties, without substantially increasing the weight and/or the thickness and/or the total cost of the composite product. Furthermore, the film is sufficiently flexible to be able to be shaped by a moderate depression.

Preferably said film (and said further film) contains or it is (substantially) composed of one or more of the following polymers: polypropylene (PP), polyethylene (PE), polyamide (PA), polystyrene (PS), polymethyl methacrylate (PMMA), polycarbonate (PC), acrylonitrile butadiene styrene (ABS). According to the Applicant these polymers are suitable, in varying degrees, to give to the surface at least one of the aforementioned properties, and/or they offer sufficient chemical/physical compatibility to bond with said polyurethane material.

Preferably at least one face of said film in contact with said outer face of the first layer (and possibly a face of said further film in contact with said outer face of said second layer) is made of polyamide or polystyrene or polymethyl methacrylate or polycarbonate or acrylonitrile butadiene styrene, more preferably of polyamide. In fact, the Applicant has verified that these polymers, in particular the polyamide, offer high chemical/physical compatibility (and thus stable and durable adhesion) with said polyurethane material.

Preferably said film (and said further film) contains an anti-UV filler and/or a pigment. In this way the finished product is protected from the harmful effects of UV rays and/or has a desired aesthetic appearance.

Preferably adhering said polymeric film (and said further film) to said (respective) shaping surface comprises:
applying said film (and said further film) on said first (and respectively second) half-mould, wherein said film (and further film) has a (continuous) perimetral portion that exceeds said shaping surface along a whole perimeter of the shaping surface;
applying a depression between said perimetral portion of said film and said first half-mould (and between said perimetral portion of said further film and said second half-mould), more preferably along a continuous line surrounding the respective shaping surface;
after the previous step, applying said depression between said film and said shaping surface (and between said further film and said respective shaping surface), more preferably keeping said depression between said perimetral portion of said film and said first half-mould (and between said perimetral portion of said further film and said second half-mould).

The Applicant has ascertained that the application of a first out-of-shape depression makes a pre-tensioning of the film which favours the desired spreading (e.g. low presence, or absence, of wrinkles or folds) between the film and the shaping surface after the application of the second in-shape depression.

Preferably applying said film on said first half-mould comprises:
applying said film to a frame and applying a depression between film and frame along a continuous perimetral portion of said film, to couple the film to the frame (and pre-tension the film);
subsequently applying said film on said first half-mould by approaching the frame to the first half-mould,
subsequently applying said depression between said perimetral portion of said film and said first half-mould,
subsequently removing said depression between film and frame, to be able to remove said frame from said first half-mould. Similarly, for the further film.

In this way the film can be moved and rested on the half-mould already pre-tensioned, further improving the quality of the adhesion with the shaping surface.

### BRIEF DESCRIPTION OF THE DRAWINGS

The characteristics and advantages of the present invention will be further clarified by the following detailed description of some embodiments, presented by way of non-limiting example of the present invention, with reference to the attached figures, in which:

FIG. 1 shows a perspective view of a composite product obtainable by the process according to the present invention;

FIG. 2 shows in schematic form and not in scale a partial section of a composite product obtainable by the process according to the present invention;

FIGS. 3a-3c show in purely schematic way some exemplary steps of a process according to the present invention.

### DETAILED DESCRIPTION OF SOME EMBODIMENTS OF THE INVENTION

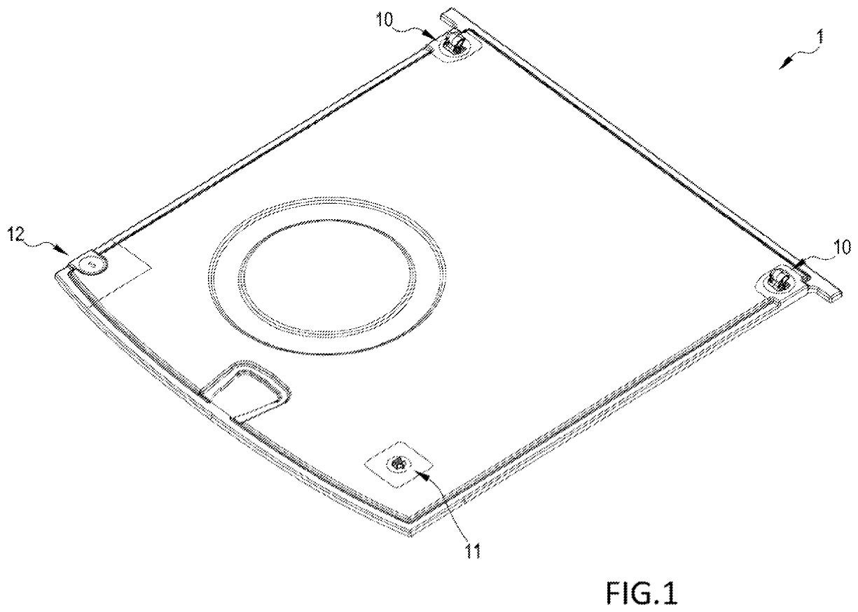

In FIG. 1 with the reference number 1 a finished composite product obtainable with the process according the present invention is shown. Exemplarily, the shown composite product 1 is a loading support of a car trunk.

Exemplarily the composite product 1 is of the sandwich panel type.

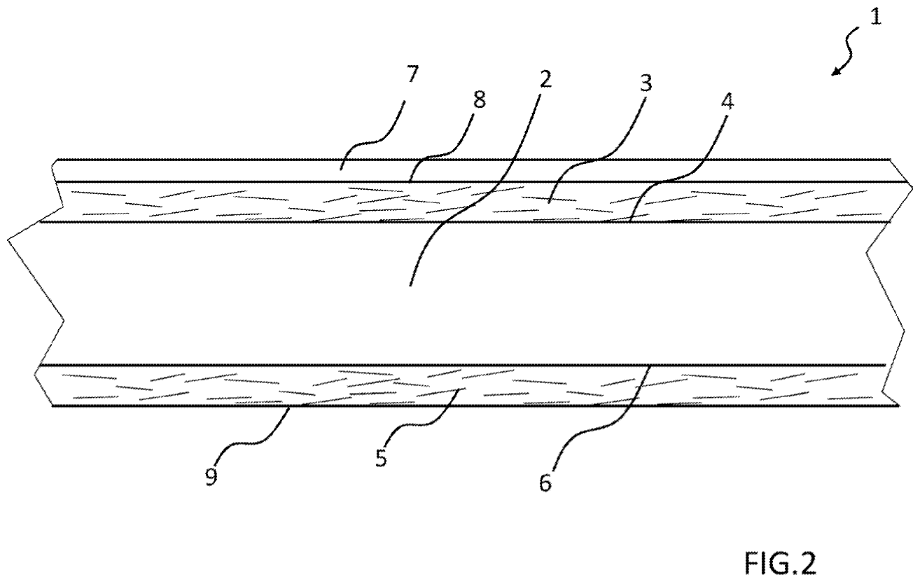

As schematically shown in FIG. 2, the composite product 1 comprises a core 2, a first layer 3 at a first face 4 of the core 2, a second layer 5 at a second face 6 of the core opposite the first face 4 and a polymer-based film 7 (for example made of polystyrene or polyamide) applied to an outer face 8 of the first layer 3 on opposite side to the first face 4 of the core 2. Optionally, not shown, a further polymer-based film (preferably equal to the film 7) is applied to an outer face 9 of the second layer 5 on opposite side to the second face 6 of the core according to the modalities described herein for the film 7 and simultaneously to the film 7.

The core 2 and the layers 3 and 5 have laminar development. The first and the second layers 3, 5 are constituted (not shown) of a respective fiberglass sheet impregnated with a solid polyurethane material. Exemplarily the thickness of the undeformed layers 3 and 5 is equal to about 0.3-0.4 mm, the thickness of the undeformed core 2 is equal to about 12-20 mm and the thickness of the film 7 is 60 μm. In FIG. 2 the thicknesses of the first and second layers 3, 5 and of the film 7 have been deliberately exaggerated to improve visibility.

Preferably the core 2 consists of a honeycomb cardboard in which the cells (not shown) are formed by walls with development substantially perpendicular to the first and second face of the core. Although not shown, the solid polyurethane material typically also partially invades the inner space of the cells near to the first and second face 4, 5, to firmly fix the first and second layer 3 and 5 to the core 2.

The composite product 1 can also (but not necessarily) comprise, as exemplary shown at the lower face visible in FIG. 1, some inserts 10, 11 and 12, rigid and in single piece, typically made of polymeric material.

Exemplarily the inserts 10 are needed to hook the loading support to a pair of pins integral with the rest of the car (not shown), realizing two hinge couplings to allow the rotation (lifting) of the loading support. Exemplarily the second insert 11 is needed to hook the loading support to the rest of the vehicle with a snap coupling. Exemplarily the third insert 12, comprising a pair of holes, is needed to ensure the correct positioning of the loading support in the hooking position.

The possibly present inserts can be fixed after the molding by means of fixing means (such as screws, rivets, etc.), or by gluing, or co-moulded together with the semi-finished product (in this case each insert comprises—not shown—a portion drowned in the first layer 3 and in the core 2 and encapsulated by the polyurethane material, and a portion protruding from the first layer 3).

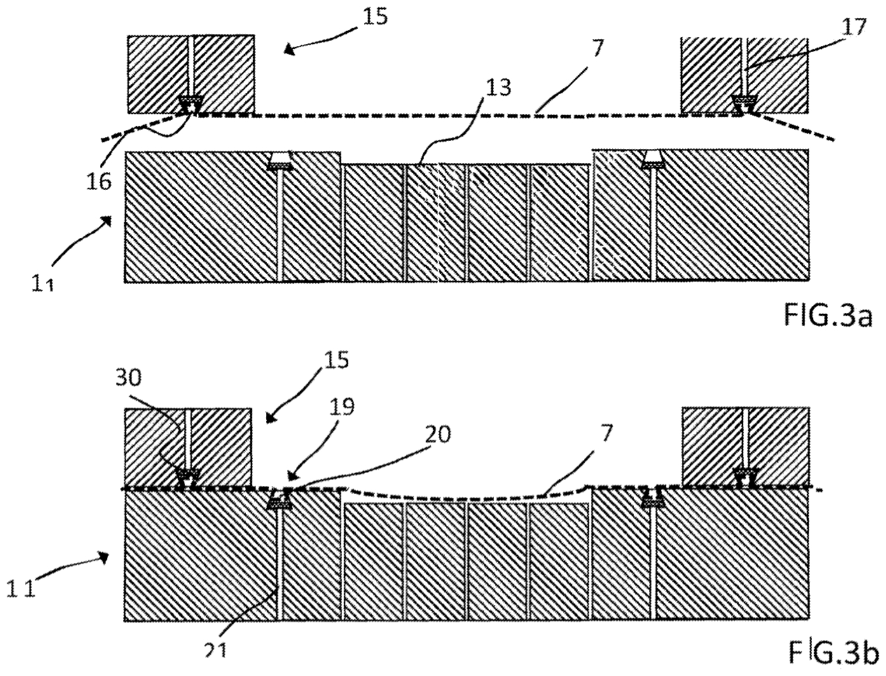

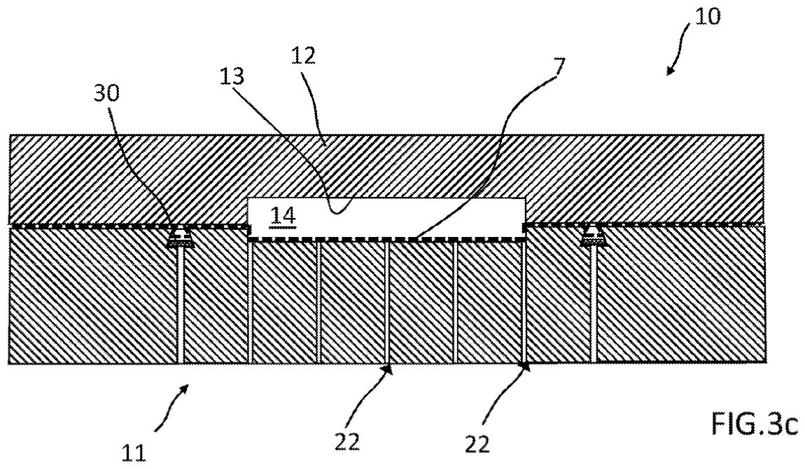

In the following an exemplary production process of a composite product according to the present invention is described, with reference to FIGS. 3a-3c which show in a purely schematic way the sections of the used elements.

The process comprises first producing a semi-finished product (not shown) arranging on the first and second face 4, 6 of the core 2 a respective fiberglass sheet and spraying the fiberglass sheets, until they are completely impregnated, with a liquid mixture of polyol and isocyanate, for example from the Elastoflex® series marketed by BASF® or from the Baypreg® series marketed by Covestro®.

The aforesaid semi-finished product is thus formed by means of a mould.

For this purpose, it is used a mould 10 comprising a first 11 and a second half-mould 12 each having a respective shaping surface 13 (shown in a purely arbitrary way in the figures) which, once the mould is closed, define a cavity 14 in which the semi-finished product is housed during forming.

In FIGS. 3a-3c the dimensions, conformations, positions of the half-moulds, of the frame, of the cavity 14 and of the suction ducts are purely arbitrary and for the sole illustrative purpose of the invention.

The process provides adhering the film 7 to the shaping surface 13 of the first half-mould (and of the second half-mould in the case of coating on both sides) by applying a depression between the film 7 and the shaping surface 13, as shown in FIG. 3c. Exemplarily it is first provided applying (e.g. approaching or resting) the film 7 to a frame 15 and applying a depression between film and frame along a continuous perimetral portion of the film 7, to couple the film to the frame and to pre-tension the film (FIG. 3a). For this purpose, for example, the frame is provided with at least one continuous groove 16 which runs along a closed path positioned externally with respect to the shaping surface 13, the groove being connected to a plurality of ducts 17 for the suction of air (the suction systems are not further described or illustrated since they are for example of known type).

Subsequently (FIG. 3b) the frame 15 is approached to the first half-mould 11 until the film contacts the half-mould.

Alternatively, the film 7 can be spread on the first half-mould 11 by means of different catching devices (for example four pliers at the four corners of the film) or even manually.

Subsequently a depression is applied between a perimetral portion 19 of the film which exceeds the shaping surface 13 along the whole perimeter of the shaping surface and the first half-mould (FIG. 3b). For this purpose for example the first half-mould is provided with at least one continuous groove 20 which runs along a closed path positioned externally with respect to the shaping surface 13, and internally with respect to the aforesaid groove 16 of the frame 15, the groove 20 being connected to a plurality of ducts 21 for the suction of the air.

Preferably suitable diffuser elements 30 are placed on the bottom of the grooves 16 and 20 to distribute the suction over the entire surface of the bottom.

Finally, a depression is applied between the film 7 and the shaping surface 13 of the first half-mould, preferably keeping the depression between the perimetral portion of film and the first half-mould. For this purpose, for example the first half-mould is provided with a plurality of ducts 22 for the suction of the air.

At this point (or even before applying the depression between the film 7 and the shaping surface 13) the depression between the frame and the film is removed and the frame is removed.

The semi-finished product is thus closed between the two half-moulds pressed against each other (FIG. 3c), so that, thanks to the pressure of the two half-moulds, the shaping surfaces of the two half-moulds conform the respective faces of the panel 1.

During the forming the blade system (not shown) of the mould cuts the semi-finished product along the contour line, and exemplarily also along a closed path to form an opening for the application of a handle on the finished loading support (FIG. 1).

Exemplarily the pressure exerted on the two half-moulds is approximately 300 tons, largely due to the cutting action.

Subsequently the semi-finished product is kept in the mould thermostated at a temperature of about 140° C. for a given time interval, for example one minute, in order to thermoset the liquid mixture to transform it into the solid polyurethane material and thus make the composite product 1. The mixture which is in contact with the film 7, once hardened to form the polyurethane material, intimately and firmly fixes the film to the panel structure.

1-10. (canceled)

11. Production process of a composite product, the composite product comprising a core, at least a first layer at a first face of the core, the first layer comprising a sheet impregnated with a solid polyurethane material, and a polymer-based film applied to said first layer at the opposite side with respect to said first face of the core,
wherein the process comprises:
producing a semi-finished product comprising said core and, at the first face of the core, said sheet impregnated by a liquid mixture precursor of said solid polyurethane material;
providing a mould comprising two half-moulds each having a respective shaping surface;
adhering said film to said shaping surface of a first of said two half-moulds by applying a depression between said film and said shaping surface;
forming the semi-finished product by pressing said two half-moulds against each other with said semi-finished product interposed between the two shaping surfaces, so that said film comes into contact with the liquid mixture which impregnates said sheet at the first layer;
with the semi-finished product in the mould, thermosetting said liquid mixture to transform it into said polyurethane solid material so that said film firmly adheres to said first layer and thus producing the composite product.

12. Process according to claim 11, wherein said composite product comprises a second layer at a second face of the core opposite to the first face of the core, the second layer comprising a further sheet impregnated of said polyurethane solid material, and wherein said semi-finished product comprises, at the second face of the core, said further sheet impregnated with said liquid mixture precursor of said polyurethane solid material.

13. Process according to claim 12, wherein said composite product comprises a further polymer-based film applied on said second layer at the opposite side with respect to said second face of the core,
and wherein the process comprises:
adhering said further film to said shaping surface of a second of said two half-moulds by applying a depression between said further film and said shaping surface of the second half-mould;
during said forming the semi-finished product, said further film comes into contact with the liquid mixture which impregnates said further sheet;
during said thermosetting said liquid mixture, said further film firmly adheres to said second layer.

14. Process according to claim 11, wherein said core and/or said first and/or second layer have substantially laminar development, wherein said sheet is made of glass fiber, carbon or kevlar, or natural fibers, wherein said core comprises a honeycomb cardboard or a solid foam, and wherein said polyurethane material is based on diphenylmethane diisocyanate (MDI), and wherein said liquid mixture is a mixture of polyol and isocyanate.

15. Process according to claim 11, wherein producing said semi-finished product comprises spraying said sheet with said liquid mixture, wherein said first half-mould comprises a respective body having said shaping surface and a cutting blade system, wherein forming the semi-finished product comprises cutting said semi-finished product at least along a contour line by means of said blade system and wherein thermosetting the liquid mixture comprises keeping the semi-finished product inside the mould at a temperature greater than 120° for a given time interval.

16. Process according to claim 11, wherein said film has a thickness greater than or equal to 10 and/or less than or equal to 500 μm.

17. Process according to claim 11, wherein said film contains or it is substantially composed of one or more of the following polymers: polypropylene (PP), polyethylene (PE), polyamide (PA), polystyrene (PS), polymethyl methacrylate (PMMA), polycarbonate (PC), acrylonitrile butadiene styrene (ABS).

18. Process according to claim 11, wherein at least one face of said film in contact with said outer face of the first layer is made of polyamide and/or polystyrene (PS) and/or polymethyl methacrylate (PMMA) and/or polycarbonate (PC) and/or acrylonitrile butadiene styrene (ABS).

19. Process according to claim 11, wherein said film contains an anti-UV filler and/or a pigment.

20. Process according to claim 11, wherein adhering said polymeric film to said shaping surface comprises:
applying said film on said first half-mould, wherein said film has a continuous perimetral portion that exceeds said shaping surface along a whole perimeter of the shaping surface;
applying a depression between said perimetral portion of said film and said first half-mould along a continuous line surrounding the respective shaping surface;
after the previous step, applying said depression between said film and said shaping surface, and wherein said depression is greater than or equal to 0.1 bar and/or less than or equal to 0.9 bar.
